(19) United States
(12) Patent Application Publication
(10) Pub. No.: US 2006/0204190 A1
(43) Pub. Date: Sep. 14, 2006

(54) Large mode-area microstructure optical fiber

(75) Inventor: Jinendra K. Ranka, Westford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Massachusetts Institute of Technology, Cambridge, MA (US)

(21) Appl. No.: 11/077,982

(22) Filed: Mar. 11, 2005

(51) Int. Cl. G02B 6/02

(52) U.S. Cl. 385/123

(57) ABSTRACT

A large mode-area microstructured optical fiber includes a core, at least one axially oriented element disposed in the core, and a cladding about the core. The axially oriented element has a refractive index less than a refractive index of the core. The axially oriented element(s) defines sectional regions in the core. The sectional regions defined by the axially oriented element(s) can discriminate between symmetric and antisymmeteric modes of an optical beam that propagates through the optical fiber.

### GOVERNMENT SUPPORT

The invention was supported, in whole or in part, by a grant F 19628-00-C-0002 from the United States Air Force. The Government has certain rights in the invention.

### BACKGROUND OF THE INVENTION

Optical fibers are characterized by their structure and by their properties of transmission. Typically, optical fibers are classified into two types: single mode fibers and multimode fibers. Single mode fibers have a relatively small core size as compared to multimode fibers. Also, single mode fibers have a higher information capacity than multimode fibers, and are capable of transferring higher amounts of data due to low fiber dispersion. Thus, for example, single-mode, rare-earth-doped, fiber lasers and amplifiers are widely used in telecommunications and other applications requiring compact, rugged, optical sources with high beam quality.

Traditional single-mode optical fibers are, however, limited in the maximum effective core-area due to the minimum achievable core-cladding index contrast as well as the increase of bending loss at larger diameters. As the power handling requirements of optical fibers increases above several Watts, the potential for damage to the single-mode fibers becomes a significant problem due to the high optical intensities associated with the high power. For example, the optical intensity for 1-kW fiber laser with a 10-micron diameter fiber core is about 1 GW/cm², whereas the damage threshold in pure silica is about 5 GW/cm². One solution for this problem is to increase the effective core-area to reduce the intensity of the confined optical beam, for example, through use of a multimode fiber having a relatively large core. However, achieving single-mode propagation in such a large-diameter fiber with a conventional fiber design is difficult due to increased mode-coupling as the core diameter is increased (see, for example, M. E. Fermann, “Single-mode excitation of multimode fibers with ultrashort pulses,” Opt. Lett. 23, 1 (1998)). Typically, multimode optical fibers suffer from a loss in quality of the delivered beam due to increased modal dispersion. This increase in mode-coupling is in part due to manufacturing defects known as microbends. The mode-coupling can be reduced by increasing the cladding diameter, but at the expense of a decrease in the core-cladding area overlap resulting in a decrease of the pump absorption.

In addition to the long term fiber reliability at high power levels, high-power optical fiber systems, to be used in, for example, high-energy-laser (HEL) applications, need to overcome the limitations of nonlinear optical effects. Nonlinear optical effects limit the power that can be transmitted in a long fiber due to the tight confinement and long lengths of the fiber. Recent laboratory results have reported output powers exceeding 1-kilowatt; however, the output was either not in diffraction-limited beam quality (see A. Liem et al., “1.3 kW Yb-doped fiber laser with excellent beam quality,” In Conference on Lasers and Electro-Optics 2004, postdeadline paper CPDD2) or had an output spectrum about 30 nm wide (see D. J. Richardson et al., “The rising power of fiber laser technology” In Europhoton Conference 2004, paper TuB1). Today, no-kilowatt class laser demonstration is believed to be compatible with wavelength or coherent beam combining architectures (see S. J. Augst et al., “Wavelength beam combining of ytterbium fiber lasers,” Opt. Lett. 28, 5, 331-333 (2003)) that can be scaled up to HEL levels. The beam combining techniques require spectral and/or phase control, and consequently nonlinear effects need to be small. For example, for output power levels greater than 1-kilowatt and optical bandwidth less than 25 GHz, a 50-micron core-diameter optical fiber that can propagate a beam with diffraction-limited beam quality for several meters would be needed to remain below the threshold for stimulated Raman scattering (SRS) and stimulated Brillouin scattering (SBS) (see, for example, G. P. Agrawal, “Soliton Lightwave Systems” In Nonlinear Fiber Optics, Academic Press, 1995, ch.8). SRS and SBS are major nonlinear processes that cause nonlinear effects and limit the optical power.

Therefore, there is a need for a new class of optical fiber designs that will allow the effective core-area of a single-mode optical fiber to be substantially increased while maintaining favorable guiding properties. These new optical fibers could allow for diffraction-limited fiber lasers and amplifiers scalable to, for example, kilowatt average power levels while maintaining sufficiently good spectral purity and/or beam quality for beam combined systems.

### SUMMARY OF THE INVENTION

A large-mode optical fiber of the present invention utilizes microstructures in the form of axially oriented elements in the core that run longitudinally along the fiber to significantly alter the waveguide mode properties of the fiber.

One aspect of the present invention includes an optical fiber comprising a core, at least one axially oriented element disposed in the core, and a cladding about the core. The axially oriented element(s) has a refractive index less than a refractive index of the core. The cladding has a refractive index less than the refractive index of the core for guiding light axially through the core. The at least one axially oriented element defines sectional regions in the core. The sectional regions defined by the axially oriented element(s) can enhance discrimination between symmetric and antisymmeteric modes of an optical beam that propagates through the optical fiber.

The optical fiber of the invention can be used for optical fiber amplifiers, optical fiber lasers, or optical communications systems for transmitting and receiving data such as medical images. With the optical fiber of the invention, the optical fiber-based systems, such as optical fiber lasers and amplifiers, can be scalable to kilowatt average power levels while maintaining sufficiently good spectral purity and/or beam quality.

Accordingly, another aspect of the present invention includes a system employing the optical fiber of the invention, as shown in FIG. 1. The system includes a source for generating optical beams, an object receiving optical beams from the source, and an optical fiber through which the optical beams propagate. The optical fiber for the system includes a core, at least one axially oriented element, and a cladding. Features of the core, axially oriented element(s), and cladding are as described above.

Yet another aspect of the present invention includes a method of propagating an optical beam from a source to an object. The method includes transmitting an optical beam having multiple modes through an optical fiber medium. The method also includes causing or forcing modes of the optical beam to propagate through the optical fiber medium in multiple sectional regions spanning the length of the optical fiber medium. In one embodiment, symmetric modes of the optical beam are caused or forced to be favored over antisymmetric modes. In another embodiment, antisymmetric modes of the optical beam are caused or forced to be favored over symmetric modes. Yet another aspect of the present invention includes an optical fiber that includes means for causing or forcing modes of the optical beam to propagate through an optical fiber medium in multiple sectional regions spanning the length of the optical fiber medium.

The present invention also includes a method of manufacturing an optical fiber. The method includes forming a fiber preform having a center material and a circumferential material. The circumferential material has a refractive index lower than a refractive index of the center material. The method also includes forming at least one axially oriented structure within the center material of the preform. The axially oriented structure has a refractive index less than the refractive index of the center material. The method further includes drawing an optical fiber from the fiber preform. The center and circumferential materials form a core and a cladding of the optical fiber, respectively. The axially oriented structure(s) forms axially oriented element(s) and defines sectional regions in the core of the optical fiber.

With the micro-structured optical fiber of the invention, it is possible to scale the fiber diameter, for example, equal to or greater than 30 micron, but yet still maintaining diffraction-limited beam quality. In addition, higher doping concentrations can be possible as the guiding properties are not limited by the requirement for small core-cladding index differences.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a system employing an optical fiber according to the principles of the present invention.

FIG. 2 is a graph showing a fiber index profile of a standard single-mode fiber.

FIG. 3A is a schematic diagram of an embodiment of an optical fiber of FIG. 1 where the axially oriented elements are continuous along the axis.

FIG. 3B is a schematic diagram of another embodiment of the optical fiber of FIG. 1 where the axially oriented elements are discontinuous along the axis.

FIG. 4A is a schematic cross-sectional view of another embodiment of the optical fiber of FIG. 1.

FIG. 4B is a schematic cross-sectional view of yet another embodiment of the optical fiber of FIG. 1.

FIG. 5 is a diagram showing modes of multimode fibers and their interactions with one another.

FIG. 6A is a schematic cross-sectional view of the optical fiber of FIG. 3A.

FIG. 6B shows simulated symmetric-mode structures in the optical fiber of FIG. 6A.

FIG. 6C shows simulated antisymmetric-mode structures in the optical fiber of FIG. 6A.

FIG. 7A is a schematic diagram showing a process for drawing an optical fiber from a fiber preform according to the principles of the present invention.

FIG. 7B is an overview of the fiber preform of FIG. 7A used for drawing an optical fiber.

FIGS. 8A-8B are pictures of an optical fiber having a similar profile as that of FIG. 6A.

FIG. 9A is a simulation of a fundamental mode profile of the optical fiber of FIG. 3A incorporating three air voids in the core region.

FIG. 9B is a simulation of an antisymmetric mode LP₁₁ profile of the optical fiber of FIG. 3A incorporating three air voids in the core region.

FIG. 9C is a picture showing an experimentally measured mode profile for the optical fiber of FIG. 3A with a 30-micron core-diameter.

FIG. 9D is a picture showing an experimentally measured mode profile of a fiber without the voids of the fiber of FIG. 9A.

### DETAILED DESCRIPTION OF THE INVENTION

A description of preferred embodiments of the invention follows.

The optical beam propagating through an optical fiber according to the principles of the present invention can be modulated in any way known in the art, such as short pulses and frequency, phase and intensity modulations.

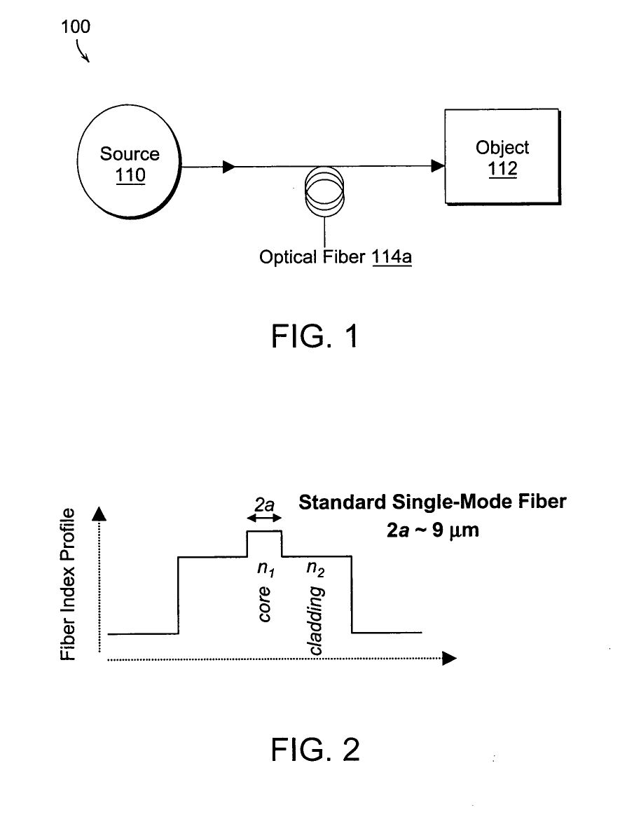

FIG. 1 is an example communications system 100 or other type of system optionally employing an optical fiber 114a according to the principles of the present invention. Typically, optical fibers are thin cylindrical dielectric waveguides which are used to send and/or receive light energy for applications, such as optical communications. An optical fiber, either single-mode fiber or multimode fiber, in general includes a core and a cladding, where a refractive index of the core is greater than a refractive index of the cladding for guiding wavelengths that propagate through the optical fiber. That is, light is guided by total internal reflection at the core-cladding boundary.

A fiber index profile for a standard single-mode fiber is shown in FIG. 2. As shown in FIG. 2, the core size of single mode fibers is small, typically around 4 to 10 microns. In single mode fibers, because the core size approaches the operational wavelength, only the fundamental or lowest order mode is allowed to propagate through. On the other hand, multimode fibers can propagate more than one mode, typically a few to hundreds modes. The number of modes propagating depends on the core size and numerical aperture (NA), both of which are positively related to the number of modes propagating. Typical values of fiber core size of multimode fibers are 50 to 100 microns. As used herein, the numerical aperture (NA) is the sine of the half-angle of the cones of acceptance, which is also characterized by:
NA=(n₁²−n₂²)^{1/2} (1)
where n₁ and n₂ are refractive indices of the core and cladding. Single-mode fibers typically have an NA of about 0.1, whereas the NA of multimode fibers is in the range of 0.2 to 0.3.

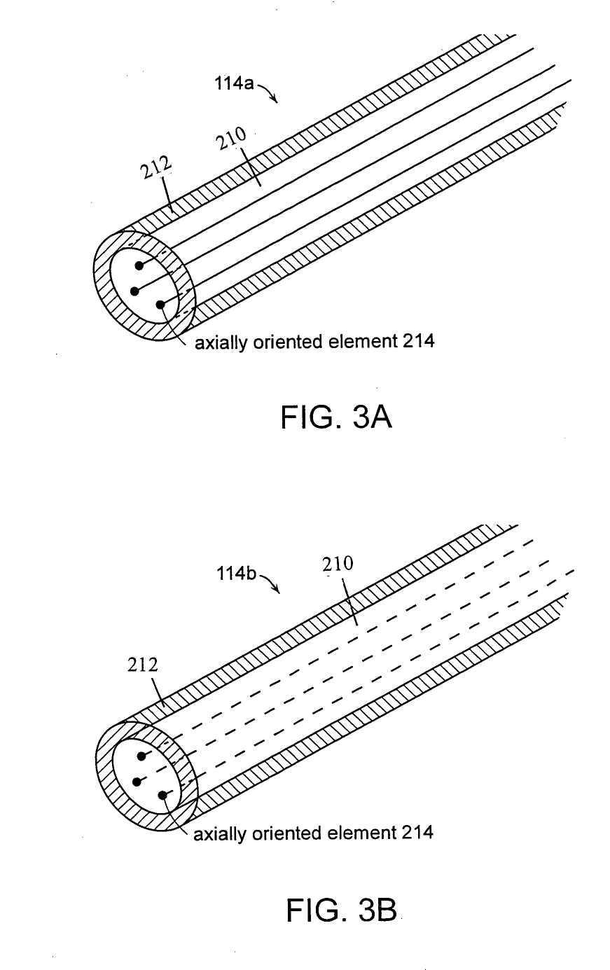

FIG. 3A is a schematic diagram of an embodiment of the optical fiber 114a of FIG. 1. Unless otherwise specified, it is assumed that the optical fiber 114a and all later embodiments (collectively optical fibers 114) thereof, are made according to and include structures of the principles of the present invention. In particular, the optical fiber 114a includes a core 210, at least one axially oriented element 214 in the core 210, and a cladding 212 that surrounds the core 210.

Preferably, the profile of the optical fiber 114a is similar in size and core-cladding indices to conventional multimode optical fibers. Also, the refractive index profile of the optical fiber 114a may be a step-index profile or may be a graded index profile. Also, the refractive index profile of the optical fiber 1 14a may have multiple index steps. The optical fiber 114a may have multiple cladding regions. In some embodiments, the cladding 212 of the optical fiber 1 14a is a photonic crystal cladding. To protect the core 210 and cladding 212 from damage that might result from abrasion and external pressures, optionally a coating known in the art which surrounds the cladding may also be included in the optical fiber 114a.

The optical fiber 114a employs at least one axially oriented element 214 that has a refractive index less than a refractive index of the core 210. Since the axially oriented element(s) 214 has a refractive index less than a refractive index of the core 210, it is generally understood that light is guided by total internal reflection at the core-axially oriented element(s) boundary as well as at the core-cladding boundary. Thus, in general, the axially oriented element(s) 214 does not primarily participate in guiding light propagating through the optical fiber 114a. With the axially oriented element(s) 214, sectional regions 216 are defined in the core 210, which discriminate between symmetric and antisymmetric modes of an optical beam. The axially oriented element(s) 214 may define an odd number of sectional regions in the core 210 for favoring symmetric modes. Alternatively, the axially oriented element(s) 214 may define an even number of sectional regions in the core 214 for favoring antisymmetric modes.

The axially oriented element(s) 214 may be continuous along the core 210, as illustrated in FIG. 3A, or may be discontinuous along the core 210, as illustrated in FIG. 3B. Either continuous or discontinuous, the axially oriented element(s) 214 can extend along the length of the core 210 relative to a geometric center 220 of the core 210 in any orientation, including parallel, spiral, zig-zag or random orientations, or combinations thereof. The axially oriented element(s) 214 may be positioned symmetrically around the geometric center 220 of the core 210, or, alternatively, asymmetrically around the geometric center 220 of the core 210. For example, in some embodiments, the optical fiber 114 includes at least two axially oriented elements positioned symmetrically about a geometric center of the core. In other embodiments, the optical fiber 114 includes at least one axially oriented element positioned symmetrically about a geometric center of the core.

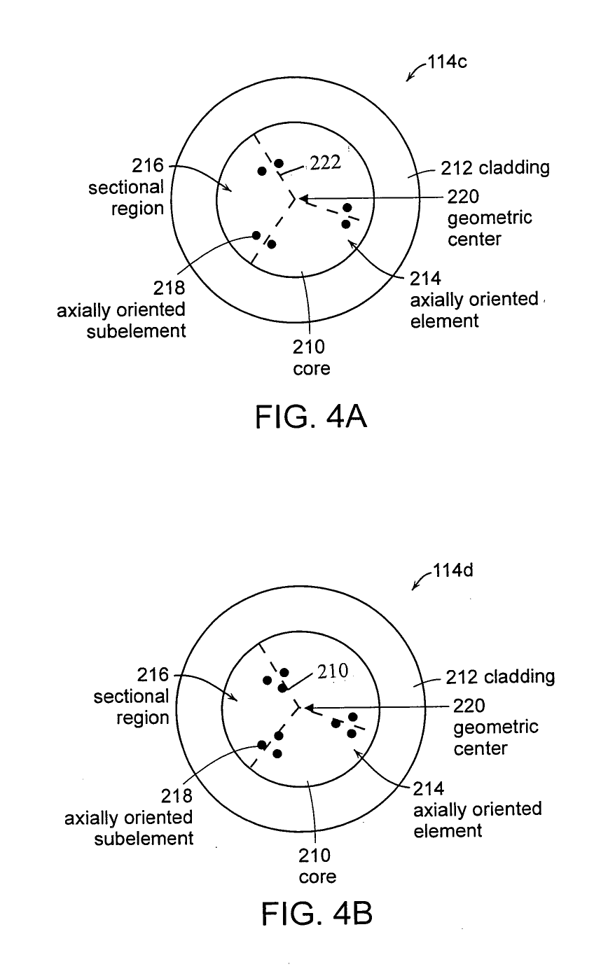

FIGS. 4A and 4B are schematic cross-sectional profiles of other embodiments of the optical fiber 114c and 114d, respectively, according to the principles of the invention. As shown in FIGS. 4A and 4B, the optical fibers 114c and 114d each include the core 210, cladding 212, and axially oriented elements 214. The axially oriented elements 214 define sectional regions 216 in the core 210.

Typically, each of the axially oriented elements 214 i) is placed at some distance between the geometric center 220 of the core 210 and the edge of the core 210 adjacent to the cladding 212, and ii) is small in dimension compared to the size of the core 210. Preferably, each of the axially oriented elements 214 is located at least about ¼, more preferably at least about ⅓, of the diameter of the core 210 away from the geometric center 220 of the core 210. In some embodiments, the distance of the axially oriented element(s) 214 from the geometric center 220 of the core 210 can be closer to or farther from the core 210 as long as the fiber functions as described herein. The diameter of each of the axially oriented elements 214 is preferably small to minimize propagation losses and to maintain manufacturing simplicity. In some embodiments, the diameter is less than ⅕ of the diameter of the core 210.

The axially oriented elements 214 may also include at least one axially oriented subelement 218. Any number of axially oriented subelements 218 can be employed in the invention. Preferably, the number of axially oriented subelement(s) 218 is in a range of between 1 and 10. More preferably, the number of axially oriented subelement(s) 218 is one, two, or three, as shown in FIGS. 3A-3B and 4A-4B.

The number of sectional regions 216 that are defined by axially oriented elements 214 can be an odd number or an even number, so that symmetric or antisymmetric modes of an optical beam propagating through the fiber are favored, respectively. Preferably, the number of the sectional regions 216 is an odd number, so that symmetric modes of an optical beam propagating through the fiber are favored. In the example optical fibers 114c and 114d of FIGS. 4A and 4B, the number of sectional regions 216 is three, as indicated by dashed lines 222 separating the sectional regions 216.

The refractive indices of the axially oriented element(s) 214 or axially oriented subelement(s) 218 are less than a refractive index of the core. Typically, the axially oriented element(s) 214 or axially oriented subelement(s) 218 may include air, glasses, liquids, or polymers such as plastics. Preferably, air is included in the axially oriented element(s) 214 or axially oriented subelement(s) 218.

The axially oriented element(s) 214 or axially oriented subelement(s) 218 may be in a variety of shapes, e.g., essentially circular, elliptical, triangular, square, rectangular, or random. Preferably, the shape is essentially circular.

In a preferred embodiment, the core 210 has a substantially uniform density across its radius.

The optical fibers 114 according to the principles of the present invention can be any length. Preferably, the length of the optical fiber is greater than 1-cm.

The diameter of the core 210 of the optical fibers 114 may be equal to or greater than 30-micron and may also be equal to or greater than 50-micron. Diameters smaller than 30-micron are also achievable. For example, in some embodiments, the diameter of the core 210 of the optical fibers 114 is equal to or greater than 12-micron.

By controlling the number of sectional regions 216 and/or the location(s) and/or size(s) of the axially oriented element(s) 214, certain modes of an optical beam propagating through the optical fiber can be caused or forced to be suppressed. For example, either antisymmetric or symmetric modes propagating through the optical fiber can be suppressed, causing or forcing the symmetric or antisymmetric modes to be favored, respectively.

In particular, for an optical fiber 114 with core diameters as large as 30-50 microns to be used in applications where a diffraction-limited beam is required, the optical fiber 114 is designed such that higher-order modes are suppressed and coupling between modes is reduced. Coupling between orthogonal transverse modes, e.g., LP₀ₓ and LP₁ₓ, occurs generally due to deformations of the optical fibers such as microbends. Microbends are small microscopic bends of the fiber axis that occur mainly when a fiber is manufactured. An example of a microbend is a bend having a large radius of curvature relative to the fiber diameter. Since the index perturbations in optical fibers which result in mode coupling are primarily point defects and are not radially symmetric, coupling is, in general, strongest between symmetric (LP₀ₓ) and antisymmetric (LP₁ₓ) modes over a distance equivalent to a beat length between the modes.

In general, the coupling strength is characterized by the following equation:

$$Coupling Strength \approx {\int }_{1 / Δκ} \int Δ n ( r , φ , z ) {E}_{1} {E}_{2} ⅆ A ⅆ z , \qquad ( 2 )$$

where Δn(r,φ,z) represents an index perturbation and 1/Δk is the beat length between the two orthogonal modes. E₁ and E₂ represent electric field profiles of the two orthogonal modes, respectively. The beat length arises from the difference of effective refractive index between two orthogonal traverse modes. After some propagation distance (z), the two orthogonal modes will differ in phase by a multiple of 2π, resulting in a state of polarization identical to that at the input, and this characteristic length is called the “beat length” between the two orthogonal modes. As used herein, the term “beat length” is defined as in the following equation:
1/Δk=λ(n_{eff}¹−n_{eff}²) (3)
where n_{eff}¹ and n_{eff}² are respectively the effective refractive indices of two orthogonal modes of interest, and λ is the wavelength of the light in a vacuum. The effective refractive index of a mode is proportional to the phase velocity of the mode in question, and produces a phase shift on propagation which changes rather rapidly with optical wavelength.

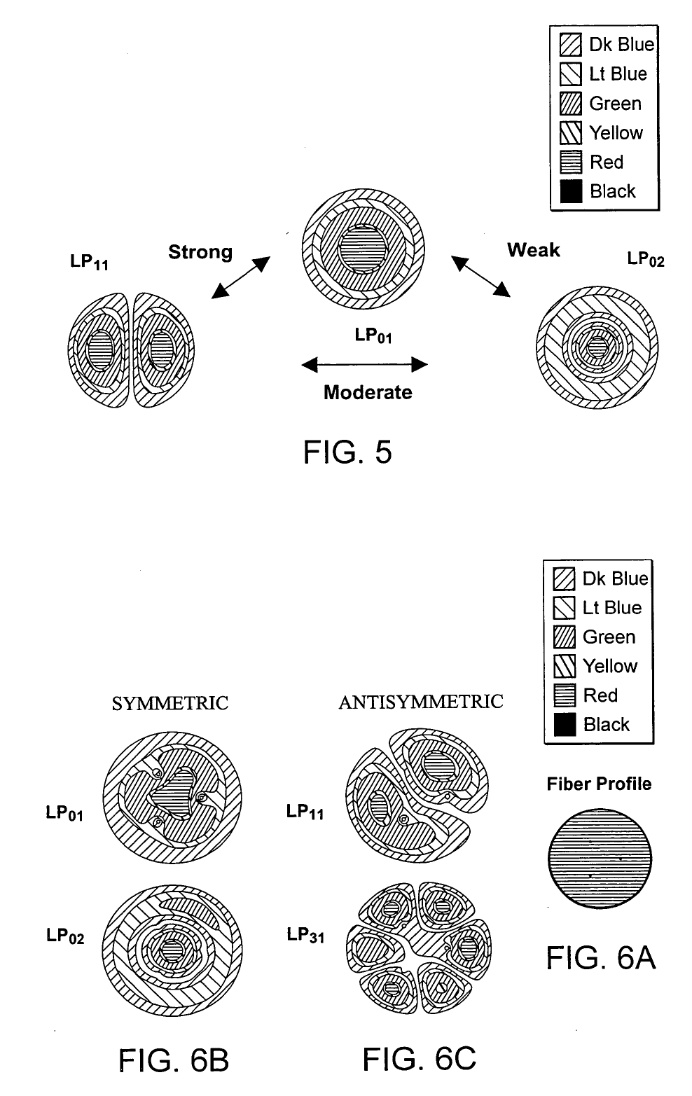

As shown in FIG. 5, the coupling between symmetric mode LP₀₁ and antisymmetric mode LP₁₁ is relatively strong as compared to that between fundamental symmetric mode LP₀₁ and a higher order symmetric mode LP₀₂. Thus, elimination of either antisymmetric modes or symmetric modes can significantly reduce mode coupling. Also, phase mismatch between the fundamental mode (i.e., LP₀₁) and higher-order modes (e.g., LP₀₂, LP₁₁, LP₃₁, etc) is increased as the higher-order modes are pulsed toward the cladding deviated from the geometric center of the core. This phenomenon may result in reduction of phase coupling of and/or reduction of overlap between, the fundamental mode with the higher-order modes.

In the optical fibers 114, the advantageous parameters, such as location(s), size(s), and number, of the axially oriented element(s) 214 to suppress a given mode or multiple given modes can be estimated by computer simulations of the given mode or multiple given modes. The computation of modal profiles of the optical fibers 114 can be done using methods known in the art. Examples include the Beam Propagation Method; the Correlation Method; and the Modal Model (See, e.g., M. D. Feit and J. J. A. Fleck “Computation of mode eigenfunctions in graded index optical fibers by the propagating beam method,” Appl. Opt., Vol. 19, 2240-2246 (1980); and R. Scarmozzino et al., “Numerical techniques for modeling guided-wave photonic devices,” IEEE J. Select Topics Ouantum Electron., Vol. 6, 150-162 (2000), the entire teachings of all of which are incorporated herein by reference).

FIG. 6A shows a schematic, cross-sectional view of the optical fiber 114a of FIG. 3A, which incorporates three axially oriented elements 214. Black dots represent the axially oriented elements 214; a dark grey-filled circle represents the core 210 of the optical fiber 114a; and a light grey square represents the cladding 212 surrounding the core 210. The three axially oriented elements 214 define three corresponding sectional regions 216.

FIGS. 6B and 6C show computer simulations of the modes of an optical beam propagating through the optical fiber 114a of FIG. 6A by the Beam Propagation Method, where the axially oriented elements 214 are air voids. As shown in FIGS. 6B and 6C, while symmetric modes, LP₀₁ and LP₀₂, are centered on the geometric center of the core 220, the antisymmetric modes, LP₁₁ and LP₃₁, are shifted from the geometric center 220 of the core 210. Thus, in the optical fiber 114a of the profile of FIG. 6A, symmetric modes can propagate through the optical fiber 114a, while the propagation of antisymmetric modes is suppressed. In addition, as described above, coupling between the fundamental mode (symmetric) and higher-order symmetric modes are weak. Therefore, with the optical fiber 114a having a similar configuration as that of FIG. 6A, essentially single-mode diffraction with diffraction-limited beam quality, can be obtained even if the fiber has a large core diameter of 50 microns or more.

In one embodiment, with the optical fiber 114a having an odd number of sectional regions 216 (e.g., three), symmetric modes (e.g., LP₀₁ and LP₀₂) are favored over antisymmetric modes (e.g., LP₁₁ and LP₃₁) of the optical beam to propagate through the optical fiber 114a. Alternatively, in the optical fiber 114a where at least one axially oriented element defines an even number of sectional regions, antisymmetric modes (e.g., LP₁₁ and LP₃₁) are favored over symmetric modes (e.g., LP₀₁ and LP₀₂) of the optical beam to propagate through the optical fiber.

A variety of types of axially oriented elements can be employed in the optical fiber of the invention with respect to numbers, locations, sizes, symmetries around the geometric center of the core, continuity along the length of the fiber, orientation extending along the length of the core relative to the geometric center of the core, shapes, materials, and compositions of the materials. These means can be employed to cause or force modes of the optical beam to propagate through an optical fiber medium, such as a micro-structured core as described above, in multiple sectional regions spanning the length of the optical fiber medium.

Referring back to FIG. 1, another embodiment of the invention is a system 100 employing the optical fiber 114a features of which are as described above. The system 100 may be an optical fiber amplifier, optical fiber laser, or optical communications system. More than one optical fiber 114a can be employed in the system 100, as desired.

Typically, in the case of an optical communications system 100, the object 112 may be a piece of terminal equipment, an optical receiver, a photodectector, an optical amplifier, etc., and the source 110 may be a transmitter that includes an optical source, e.g., a laser, that generates an optical beam. The source 110, such as a semiconductor laser, may function as either a CW source or as a pulsed (e.g. soliton) source. The optical communications system 100 may also include one or more optical devices well known in the art such as optical amplifiers, couplers, multiplexers, isolators, etc. between a first optical fiber and a second optical fiber.

For the optical amplifiers, preferably high-power optical amplifiers, the source 110 and object 112 may be polarization-independent optical isolators. One or more wavelength-selective couplers known in the art may also be included. Examples of the optical amplifiers include rare-earth-doped optical amplifiers, such as erbium (Er)-doped fiber amplifiers (EDFAs), praseodymium (Pr)-doped fiber amplifiers (PDFAs) or erbium (Er)/ytterbium (Yb)-doped amplifiers (EYDFAs).

For the optical fiber lasers, the source 110 may be an external light source such as a single-mode semiconductor laser or diode-laser array. The object 112 may be a fiber-communication or sensor network. One or more optical devices known in the art can also be included. For example, mirrors can be further employed to provide the system with the necessary feedback.

Typically, the core and outer cladding are made of glass such as silica. The core may be undoped or doped. Suitable doping materials for the core include germanium (Ge⁴⁺) and rare-earth elements, including Nd³⁺, Er³⁺, Tm³⁺, Ho³⁺, Sm³⁺, Pr³⁺, and Yb³⁺. For the applications described above, the core 210 of the optical fiber 114 according to the principles of the present invention is optionally doped with the rare-earth elements, e.g., Nd³⁺, Er³⁺, Tm³⁺, Ho³⁺, Sm³⁺, Pr³⁺, Yb³⁺ or a combination thereof.

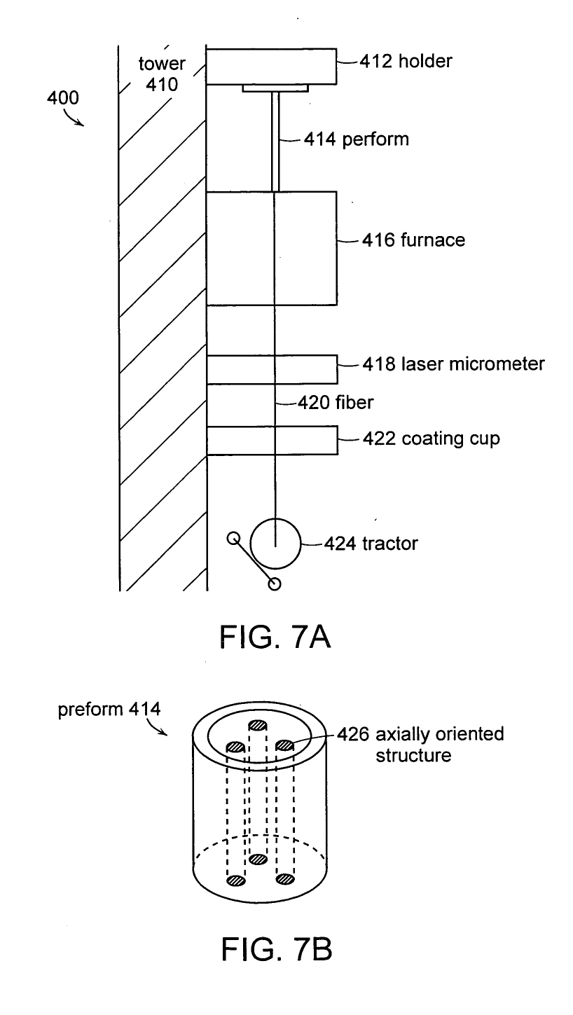

The optical fibers 114 of the invention can be manufactured from a fiber preform 414 that includes the desired profile of the optical fibers (see FIGS. 7A-7B). Typically, the fiber preform 414 includes center and circumferential materials which later form the core 210 and cladding 212 of the optical fiber 114. A typical preform 414 is several centimeters in width and a meter in length, maintaining the dimensions, microstructures, and compositional distribution in the core 210 and cladding 212 that will eventually form in the optical fiber 114.

Any suitable method known in the art can be used to form the fiber preform 414. A chemical vapor deposition (CVD) method, including a modified chemical vapor deposition (MCVD) and plasma-assisted chemical vapor deposition (PCVD), is one example of the method, in which submicron silica particles (so-called “soot”) are produced from gaseous precursors, typically SiCl₄, oxygen and optionally dopant materials such as GeCl₄, POCl₃, etc. (see, e.g., Brown, T. G., “Optical Fibers and Fiber-Optic Communications” In Handbook of Optics, 2^{nd} Ed. vol. 4, Bass, M. et al., eds. (NY: Mcgraw-Hill), Chapter 1 (2001), the entire teachings of which are incorporated herein by reference). The soot can be deposited on the surface of a glass substrate (so-called “outside process”) or inside a hollow tube (so-called “inside process”). Non-CVD tubular casting techniques such as the “rod-in-tube” method (see, e.g., Brown, T. G., “Optical Fibers and Fiber-Optic Communications” In Handbook of Optics, 2^{nd} Ed. vol. 4, Bass, M. et al., eds. (NY: Mcgraw-Hill), Chapter 1 (2001)) can also be used for the preparation of the fiber preform 414. In the rod-in-tube method, the center and circumferential materials are cast separately and combined in a final melting/collapsing step.

At least one axially oriented structure 426 (FIG. 7B) is then introduced within the center material of the fiber preform 414. The axially oriented structure 426 has a refractive index less than the refractive index of the center material. Later, the axially oriented structure(s) 426 forms corresponding axially oriented element(s) 214 or axially oriented subelement(s) 218, which defines an odd or an even number, of the sectional regions 216 in the core 210 of the optical fiber 114. In some embodiments, an odd number of sectional regions are defined. Suitable materials for the axially oriented structure(s) 426 include air, gases, liquids, glasses, and polymers such as plastics. For example, the axially oriented structure(s) 426 can be a hole(s) filled with air or combustible material(s) that can be burned out later in the drawing step.

As shown in FIG. 7A, the fiber preform 414, including at least one axially oriented structure 426, is drawn or pulled into the shape of an optical fiber. The fiber preform 414, which is fixed to a holder 412, is fed into a drawing furnace 416. The drawing furnace 416 softens the end of the fiber preform 414 to its melting point. The softened preform is pulled by a tractor 424 into the shape of a thin glass fiber 420. A laser micrometer 418 may be used to monitor the thickness of the optical fiber 420. To protect the bare fiber 420 from contaminants, the fiber 420 is typically coated by a coating material, such as an acrylate, in a coating cup 422. The coated optical fiber 420 is at this point available for use as described above in reference to the optical fibers 114.

Exemplification

### EXAMPLE 1

### Preparation of an Optical Fiber that Includes Axially Oriented Elements in the Core of the Optical Fiber

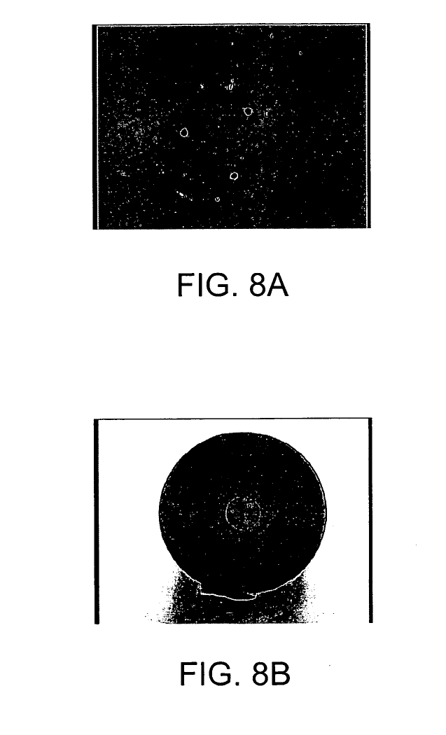

As shown in FIG. 8A-8B, an optical fiber incorporating three air voids (axially oriented elements) was prepared by drawing the optical fiber from a preform having three axially oriented structures, as shown in FIG. 7A. The core and cladding of the fiber were 29-micron and 125-micron in diameter, respectively. FIGS. 8A-8B show the same fiber with different microscope magnification. In FIG. 8A, three black dots represent the three air voids. In FIG. 8B, the three air voids appear as white dots. The air holds were 2-micron in diameter, and located 1/3.5 core diameter away from the core center.

### EXAMPLE 2

### Simulated Modes Profiles and Experimentally Measured Mode Profiles

For the optical fiber that includes three air holes, as described in Example 1, both numerical simulations and actual measurements were performed. The numerical simulations were done using the Beam Propagation Method.

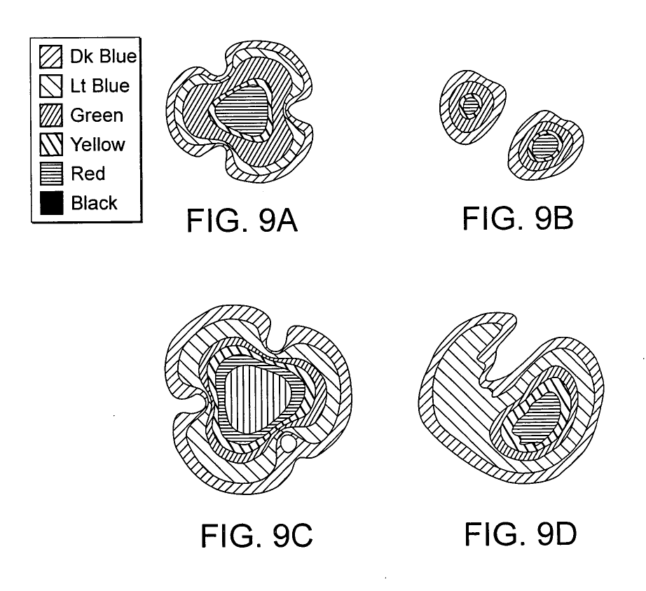

An undoped optical fiber that includes three air voids as shown in FIG. 8A-8B was used for the experiment. The core of the fiber was 30-micron in diameter, and the length of the fiber was 1-meter. The fiber had NA of 0.085. The wavelength of a beam used for the experiment was 1-micron. For the equivalent optical fiber to that used for the experiment, parallel computational calculations of the symmetric fundamental (LP₀₁) and first-order antisymmetric (LP₁₁) modes were also performed. The calculated modes are shown in FIGS. 9A and 9B, respectively. As can be seen in FIGS. 9A-9B, the symmetric fundamental mode, LP₀₁ (FIG. 9A), was modified only slightly from a near Gaussian profile, while the first-order antisymmetric mode, LP₁₁ (FIG. 9B), is shifted from the center of the fiber core, making the mode subject to be easily scattered from the core. The numerical simulations indicate that the antisymmetric modes may be unstable and easily scattered from the core in the optical fiber incorporating three axially oriented elements that define three sectional regions in the core. FIG. 9C shows the result of the measurement for the fundamental mode propagating through the optical fiber of 1-meter long, which agrees with the computational results. A control measurement for an equivalent fiber without the air voids was also performed, and the result is shown in FIG. 9D, which shows poorer output beam quality as compared to that of FIG. 9C.

While this invention has been particularly shown and described with references to preferred embodiments thereof, it will be understood by those skilled in the art that various changes in form and details may be made therein without departing from the scope of the invention encompassed by the appended claims.

1. An optical fiber, comprising:
(a) a core;
(b) at least one axially oriented element disposed in the core, said at least one axially oriented element having a refractive index less than a refractive index of the core and defining sectional regions in the core; and
(c) a cladding about the core having a refractive index less than the refractive index of the core for guiding light axially through the core.

2. The optical fiber of claim 1 wherein the sectional regions discriminate between symmetric and antisymmetric modes of an optical beam.

3. The optical fiber of claim 2 wherein the at least one axially oriented element defines an odd number of sectional regions in the core for favoring symmetric modes.

4. The optical fiber of claim 2 wherein the at least one axially oriented element defines an even number of sectional regions in the core for favoring antisymmetric modes.

5. The optical fiber of claim 1 wherein at least two axially oriented elements are disposed in the core and wherein the at least two axially oriented elements are positioned symmetrically about a geometric center of the core.

6. The optical fiber of claim 1 wherein the at least one axially oriented element is positioned asymmetrically about a geometric center of the core.

7. The optical fiber of claim 1 wherein the at least one axially oriented element is located at least about ¼ of the diameter of the core away from the geometric center of the core.

8. The optical fiber of claim 1 wherein the diameter of the at least one axially oriented element is less than ⅕ of the diameter of the core.

9. The optical fiber of claim 1 wherein the at least one axially oriented element is continuous along the core.

10. The optical fiber of claim 1 wherein the at least one axially oriented element is discontinuous along the core.

11. The optical fiber of claim 1 wherein the diameter of the core is greater than 12 μm.

12. The optical fiber of claim 1 wherein the number of the radially defined regions is three.

13. The optical fiber of claim 1 wherein the at least one axially oriented element comprises at least one axially oriented subelement, the number of said at least one axially oriented subelement being between one and ten.

14. The optical fiber of claim 1 wherein the at least one axially oriented element includes at least one of the following: glasses, gases, liquids, polymers, or air.

15. The optical fiber of claim 1 wherein the core has a substantially uniform density across its radius.

16. The optical fiber of claim 1 wherein the length of the fiber is greater than 1 cm.

17. The optical fiber of claim 1 wherein the at least one axially oriented element extends along the length of the core relative to the geometric center of the core in at least one of the following orientations: parallel, spiral, zig-zag, or random.

18. The optical fiber of claim 1, wherein the cladding of the optical fiber is a photonic crystal cladding.

19. A system, comprising:
(a) a source for generating optical beams;
(b) an object receiving optical beams from the source; and
(c) an optical fiber through which the optical beams propagate from the source to the object, the optical fiber including:
(1) a core;
(2) at least one axially oriented element disposed in the core, said at least one axially oriented element having a refractive index less than a refractive index of the core and defining sectional regions in the core; and
(3) a cladding about the core having a refractive index less than the refractive index of the core for guiding light axially through the core.

20. The system of claim 19 wherein the sectional regions discriminate between symmetric and antisymmetric modes of optical beams.

21. The system of claim 20 wherein the at least one axially oriented element defines an odd number of sectional regions in the core for favoring symmetric modes.

22. The system of claim 21 wherein the number of the radially defined regions is three.

23. The system of claim 20 wherein the at least one axially oriented element defines an even number of sectional regions in the core for favoring antisymmetric modes.

24. The system of claim 19 wherein the at least one axially oriented element includes at least one of the following: glasses, gases, liquids, polymers, or air.

25. The system of claim 19 wherein the core has a substantially uniform density across its radius.

26. The system of claim 19, wherein the cladding of the optical fiber is a photonic crystal cladding.

27. A method of propagating an optical beam from a source to an object, comprising:
configuring an optical fiber medium, including a core and a cladding about the core, to receive an optical beam having multiple spatial modes: and
reflecting an optical beam, having multiple spatial modes and propagating through the core, within the core to cause the multiple spatial modes of the optical beam to propagate through the core in multiple sectional regions spanning a length of the core.

28. The method of claim 27 wherein causing the optical beam to propagate in multiple sectional regions includes causing symmetric modes to be favored over antisymmetric modes.

29. The method of claim 27 wherein causing the optical beam to propagate in multiple sectional regions includes causing antisymmetric modes to be favored over symmetric modes.

30. The method of claim 27 wherein the number of sectional regions is an odd number.

31. The method of claim 27 wherein the number of sectional regions is an even number.

32. An optical fiber comprising
a core spanning a length of an optical fiber: and
means in the core and spanning the length of the core for causing multiple spatial modes of an optical beam to propagate through the core optical fiber in multiple sectional regions spanning the length of the core.

33. A method of manufacturing an optical fiber, the method comprising:
forming a fiber preform having a center material and a circumferential material, the circumferential material having a refractive index lower than a refractive index of the center material;
forming at least one axially oriented structure within the center material of the preform, the at least one axially oriented structure having a refractive index less than the refractive index of the center material; and
drawing an optical fiber from the fiber preform, the center and circumferential materials forming a core and a cladding of the optical fiber, respectively, the at least one axially oriented structure defining sectional regions in the core of the optical fiber.

34. The method of claim 33 wherein said at least one axially oriented structure defines an odd number of sectional regions in the core.

35. The method of claim 34 wherein the number of sectional regions in the core is three.

36. The method of claim 33 wherein said at least one axially oriented structure defines an even number of sectional regions in the core.

37. The method of claim 33 wherein each of said axially oriented structures is at least partially filled with air, gas, liquid, solid, or polymer.
